(19) United States
(12) Patent Application Publication
(10) Pub. No.: US 2013/0036075 A1
(43) Pub. Date: Feb. 7, 2013

(54) METHOD AND SYSTEM FOR TREATING PATIENTS IN ANY HEALTHCARE SETTING WITH PRESCRIPTION MEDICATIONS BASED ON A DISEASE STATE AND A FEE STRUCTURE ADJUSTED FOR A FIXED PERIOD OF TIME

(71) Applicant: JOHN D. KUTZKO, Nokomis, FL (US)

(72) Inventor: JOHN D. KUTZKO, Nokomis, FL (US)

(21) Appl. No.: 13/204,676

(22) Filed: Aug. 6, 2011

(51) Int. Cl. G06Q 50/22

(52) U.S. Cl. 705/500

(57) ABSTRACT

A method and system to treat a patient with a specific disease state, based on ICD coding, with prescription medications approved by the FDA for that disease state without regard to dosage, quantity or schedule, and calculating a cost to treat the primary or secondary ICD coding based on a fee structure adjusted for a fixed period of time, and which factors in drugs being excluded and be reflected in the cost offered to the patient or health plan.

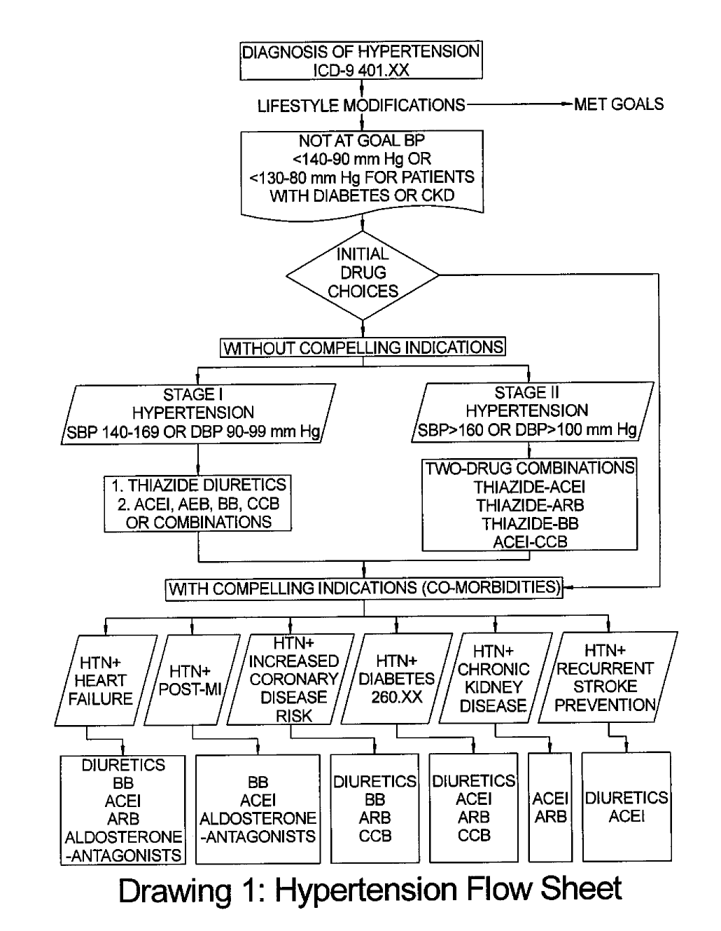

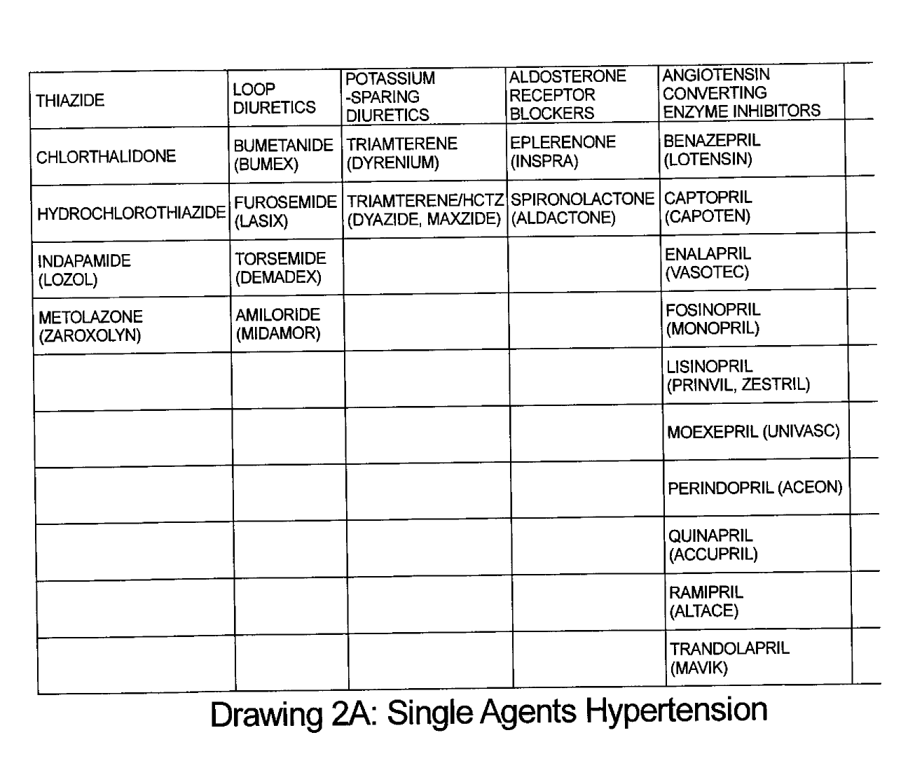

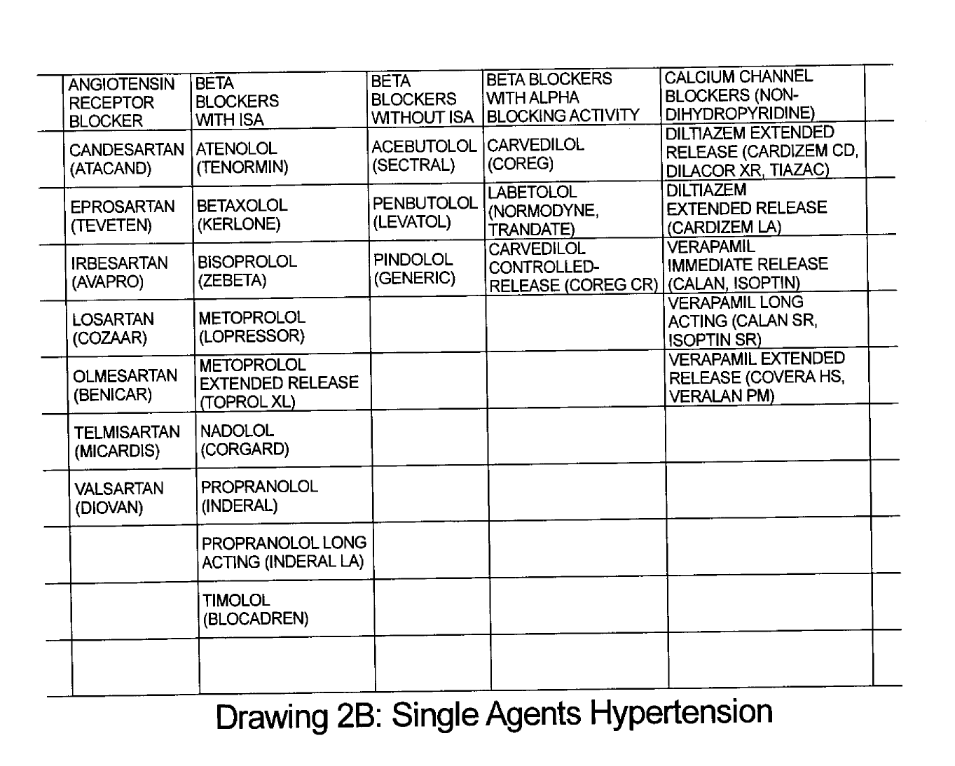

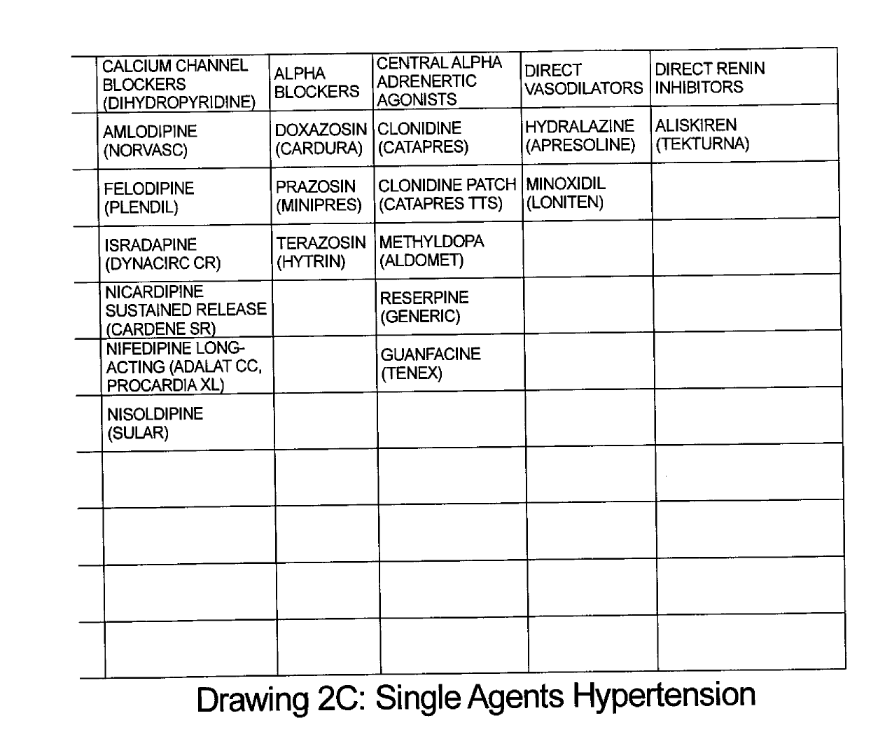

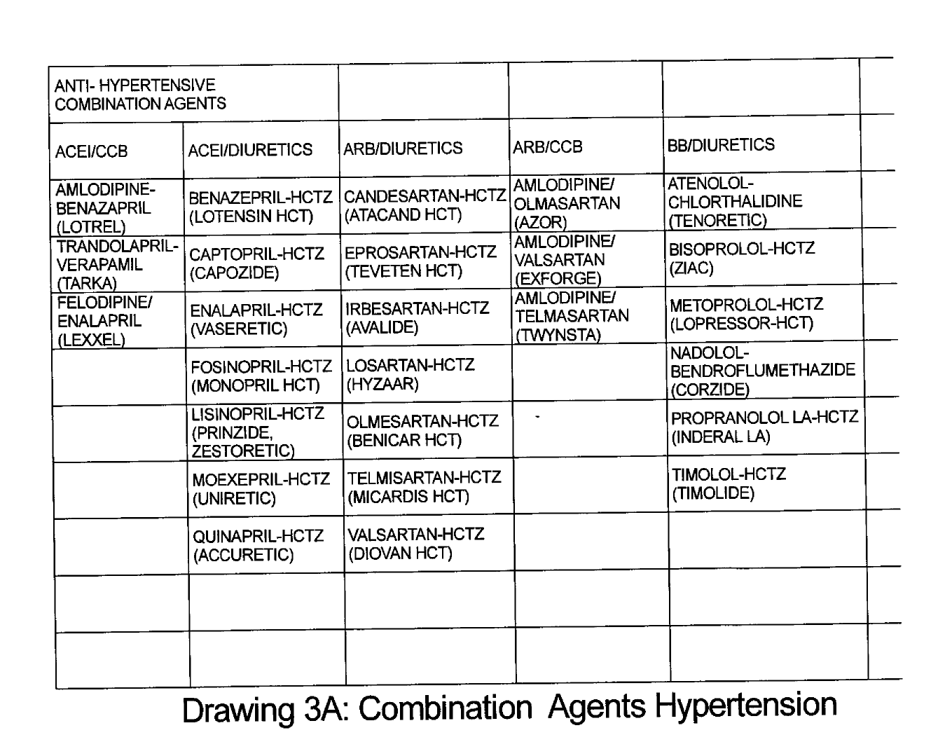

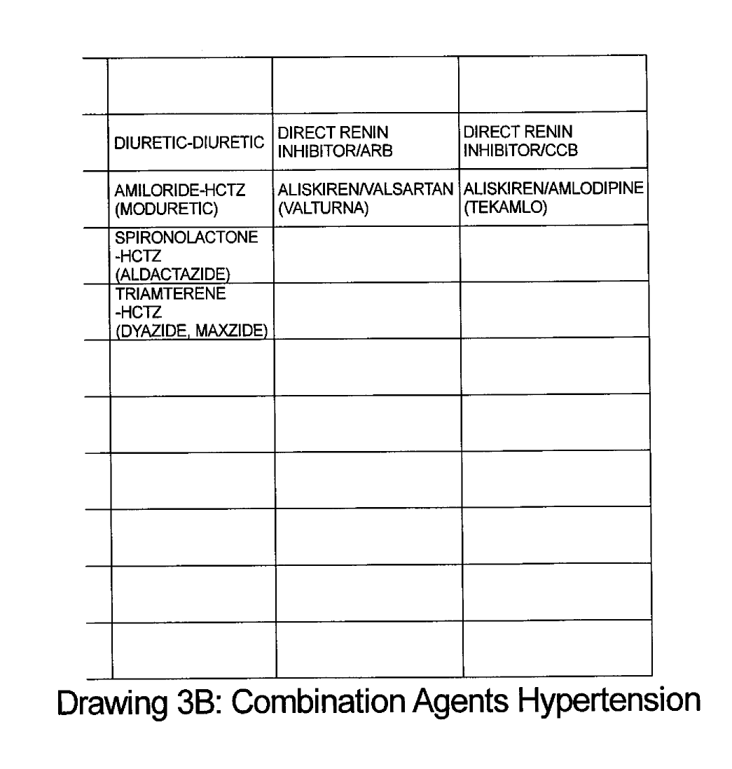

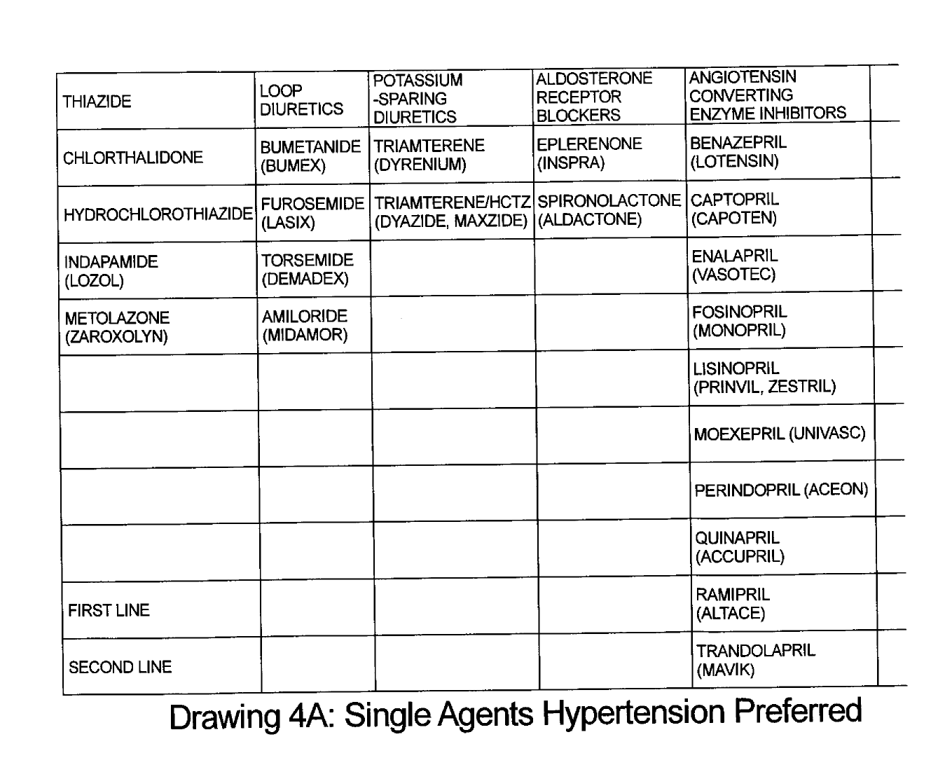

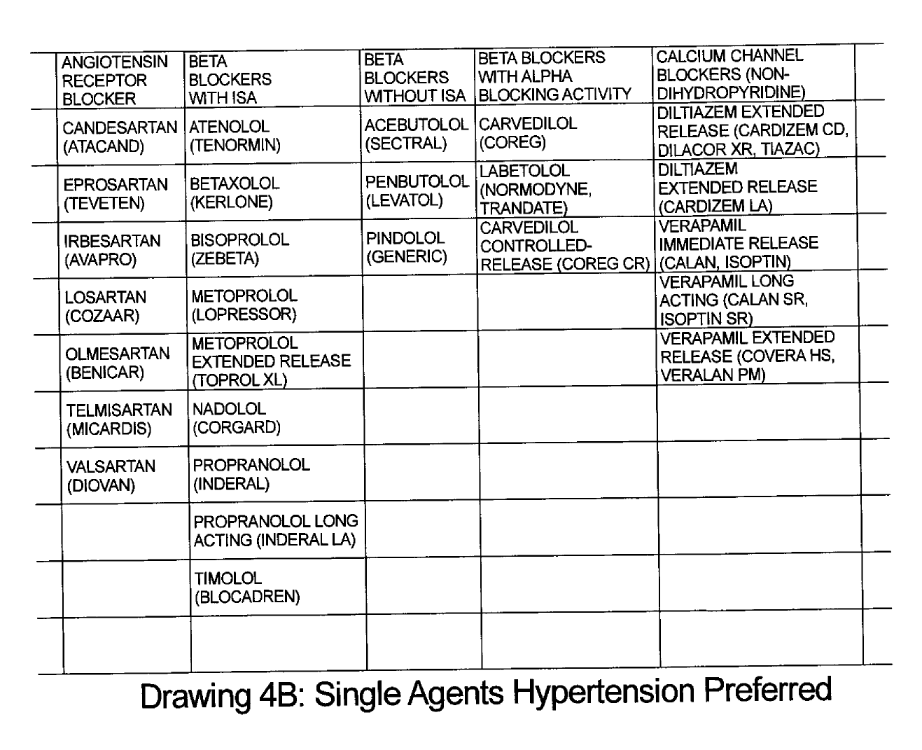

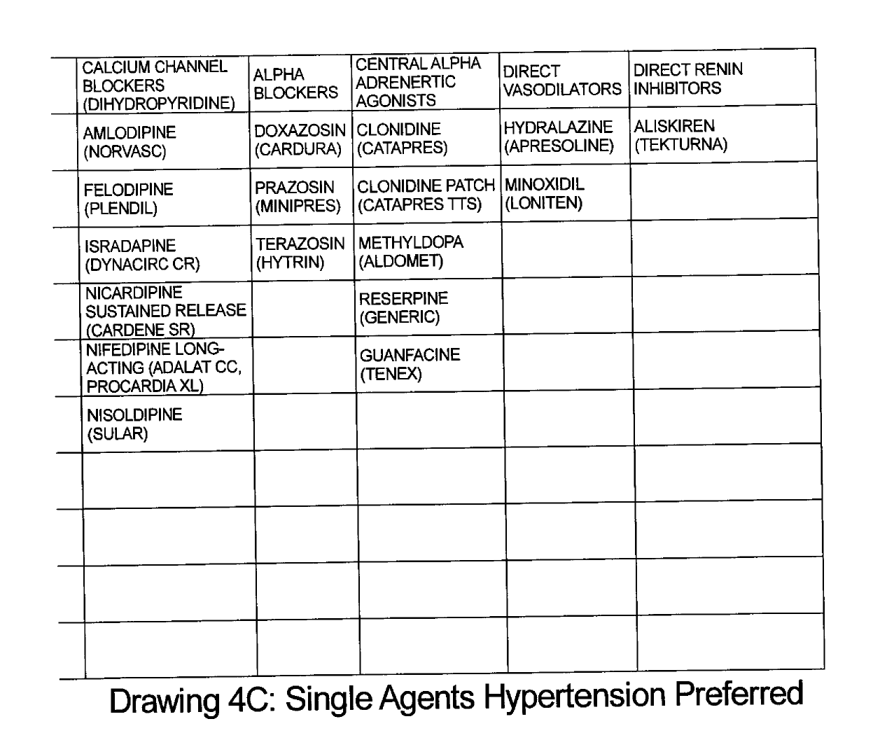

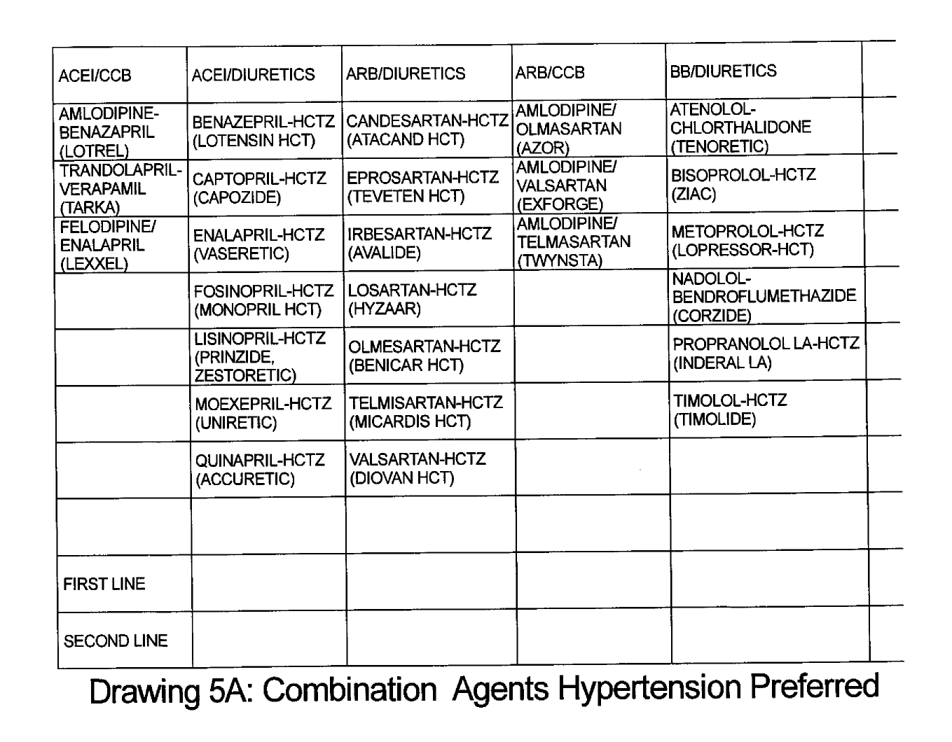

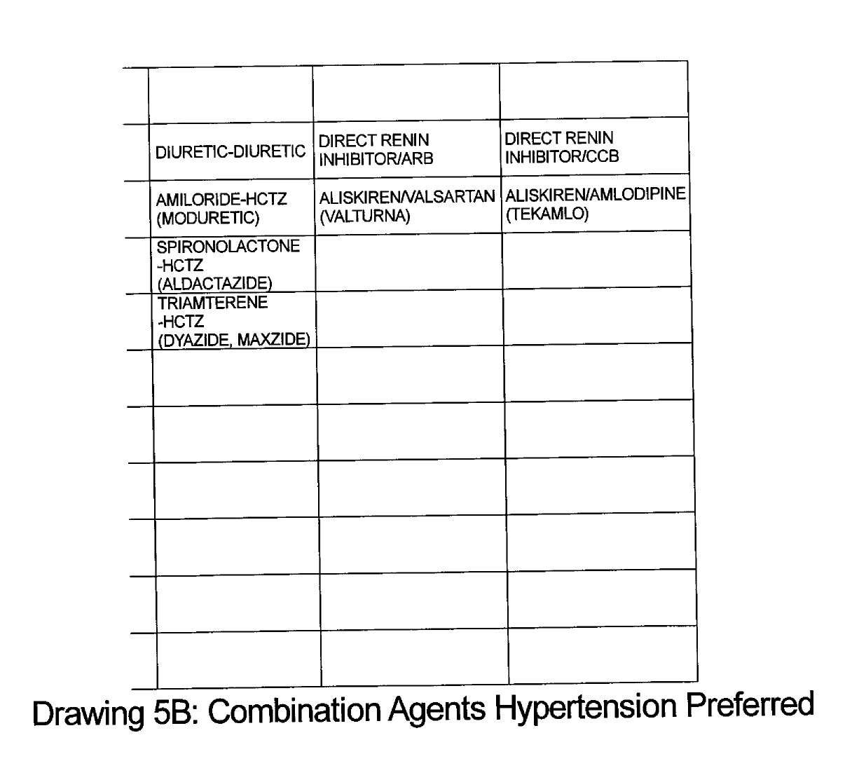

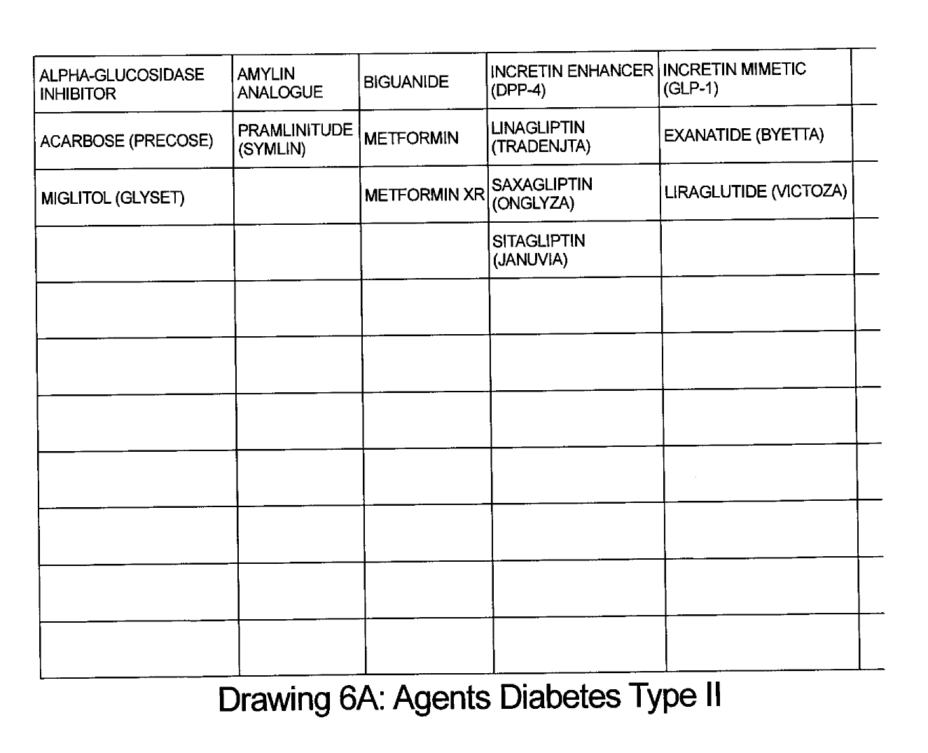

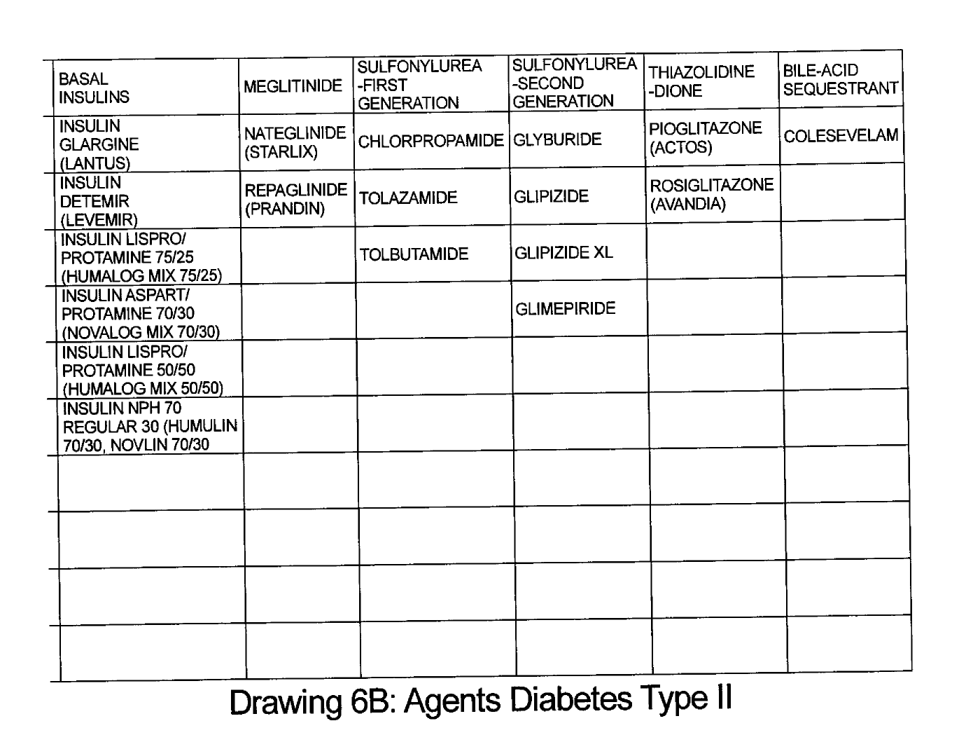

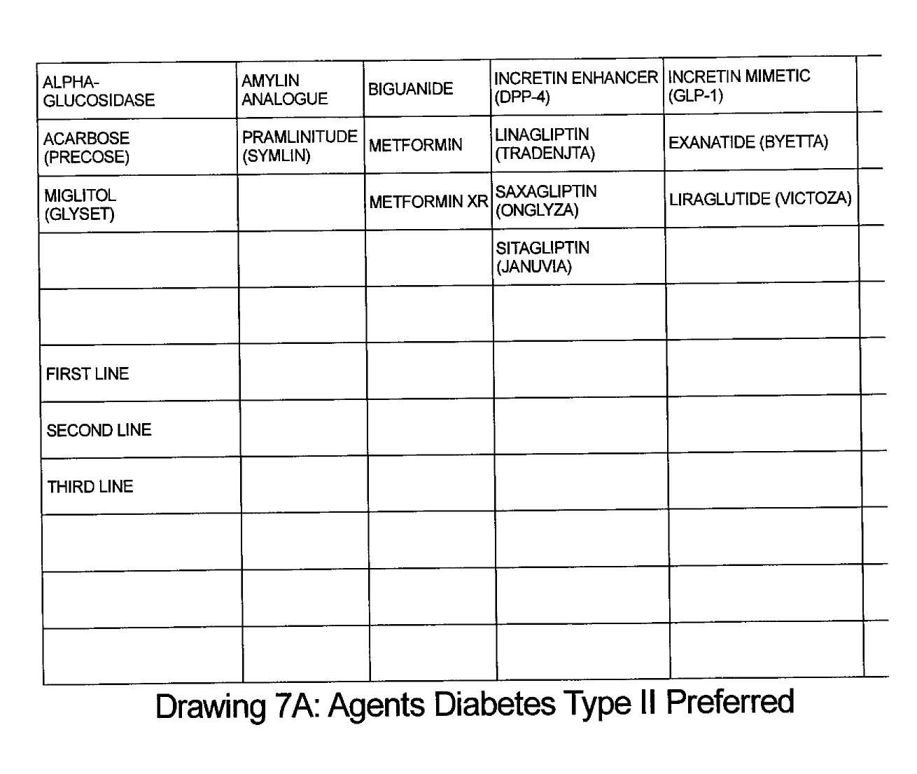

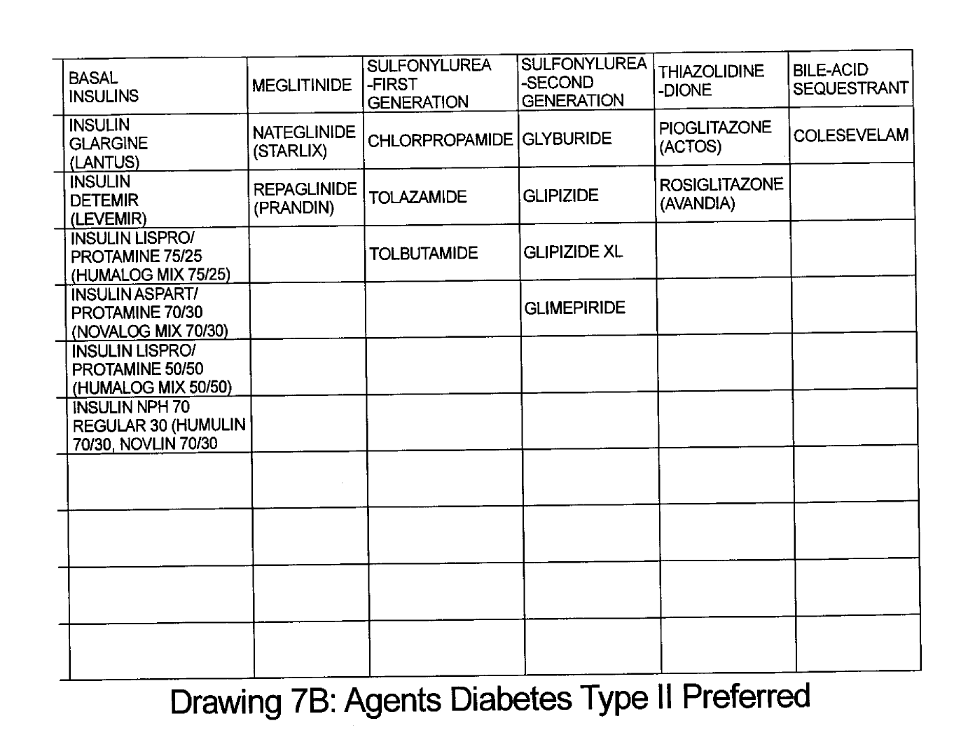

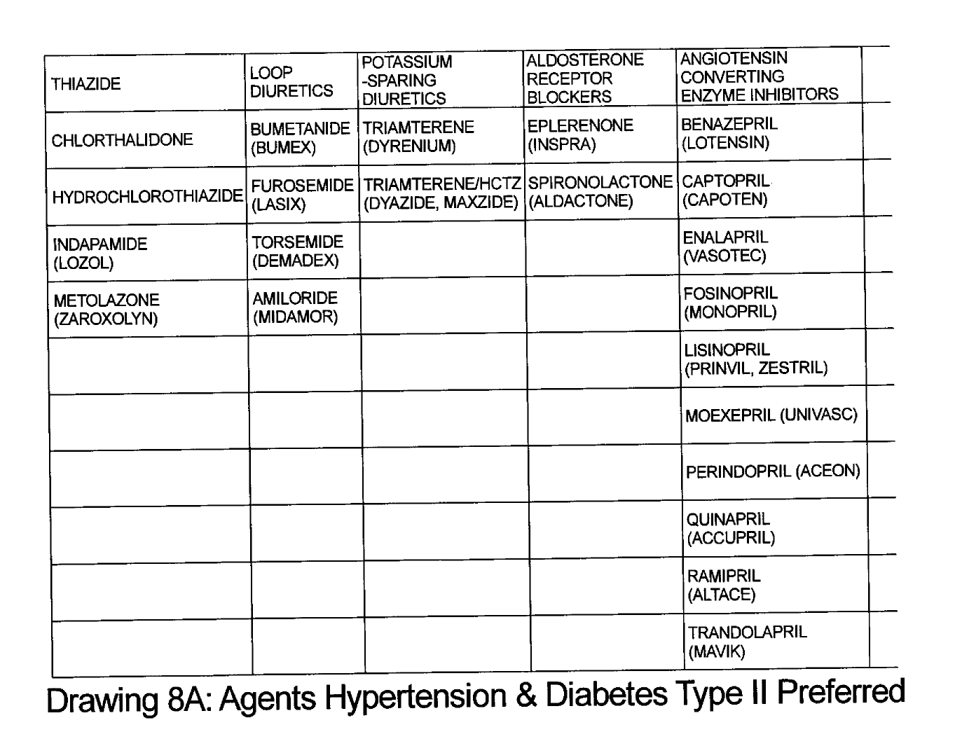

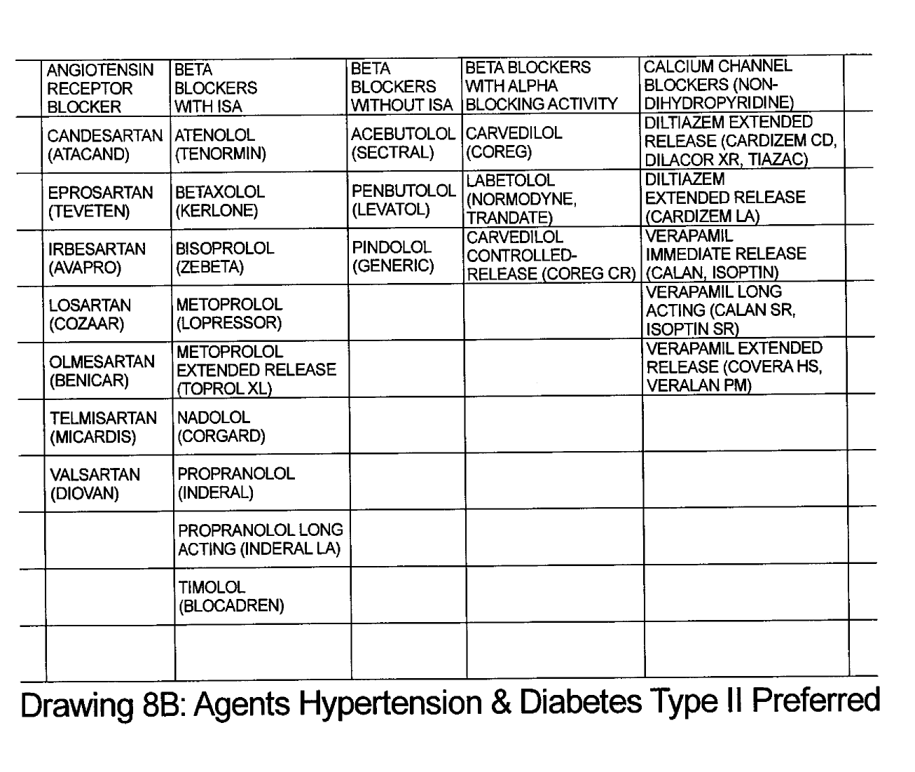

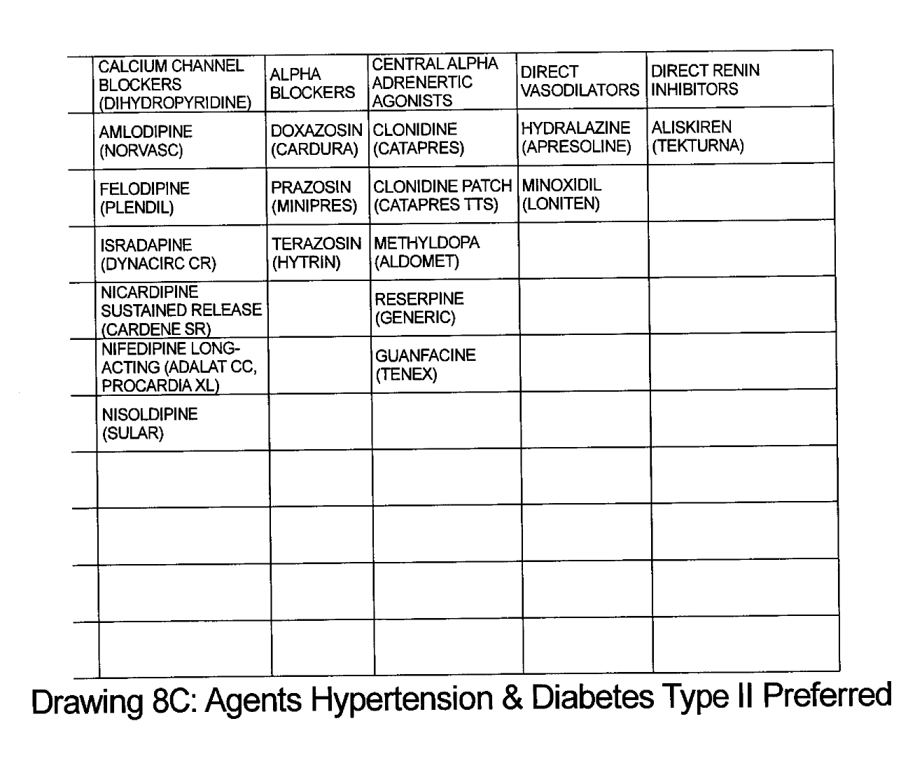

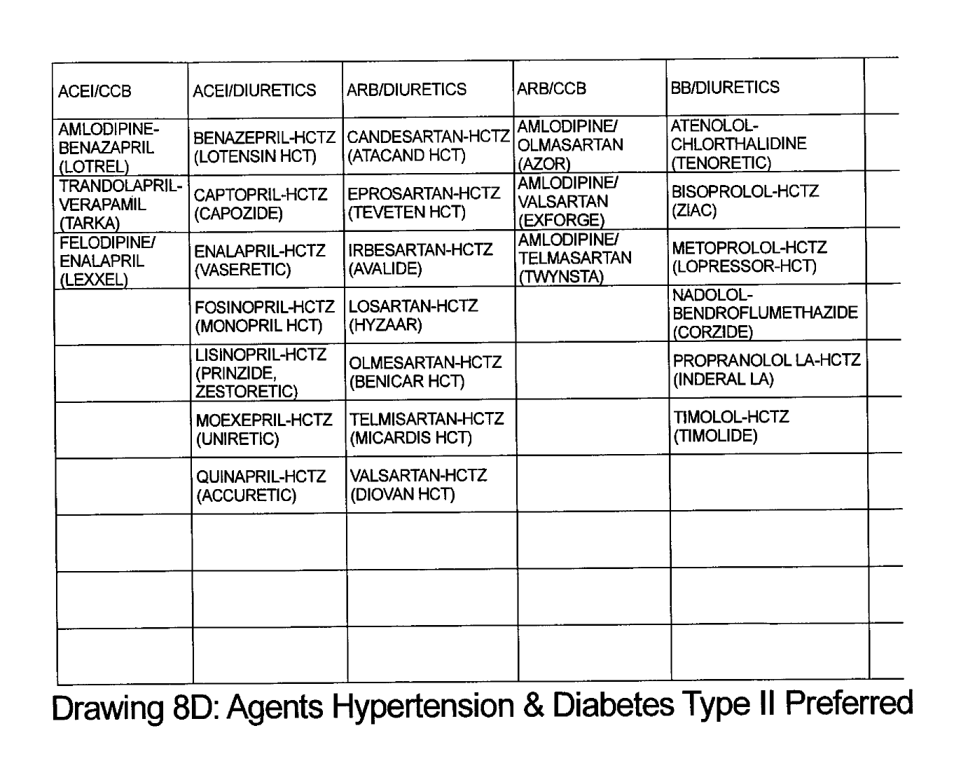

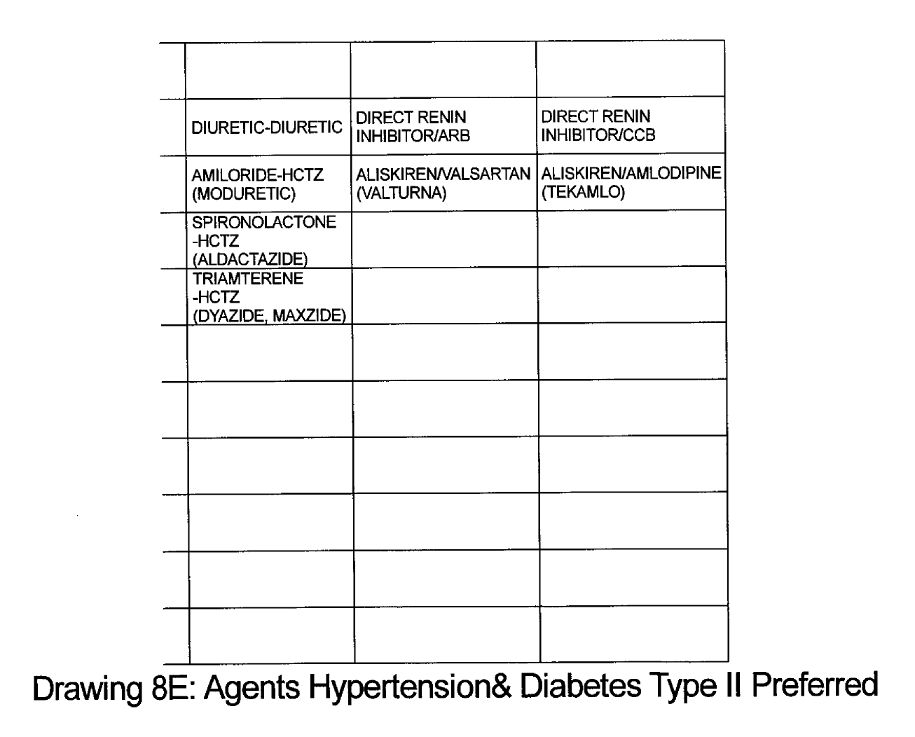

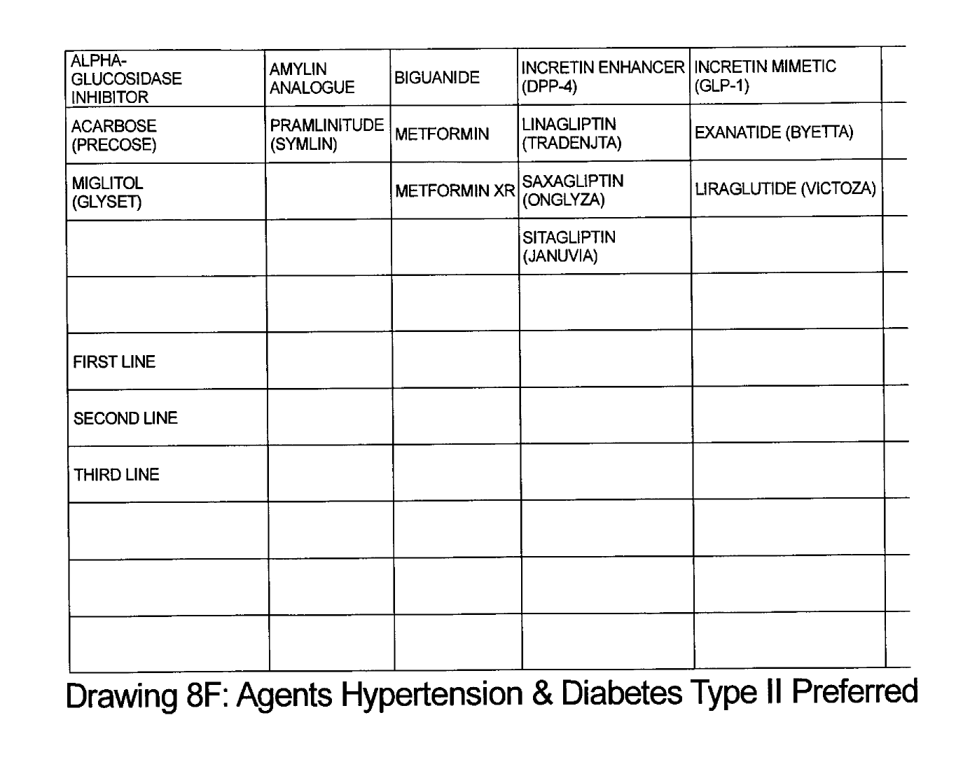

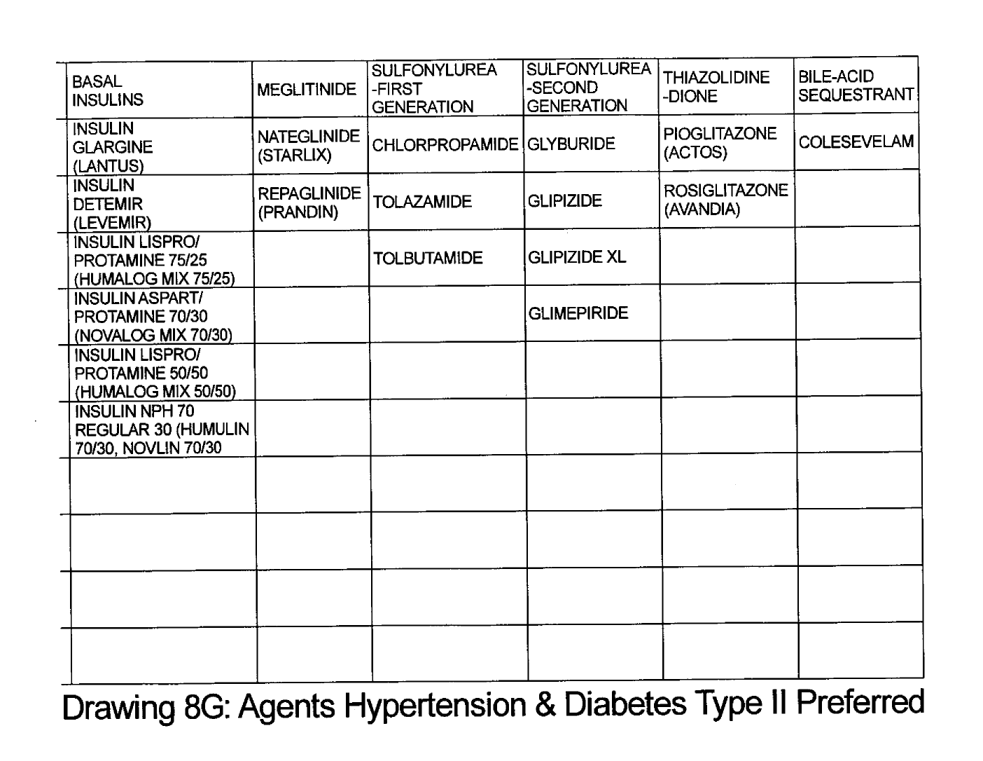

### CROSS-REFERENCE TO RELATED APPLICATIONS

Not applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The term “ICD coding” as used herein means the most recent version of ICD (International Classification of Diseases) coding that is in effect in the country in which the present invention is or will be used. The version of ICD coding changes from time to time, and varies from country to country. For example, the United States will begin official use of ICD-10 on Oct. 1, 2013, using Clinical Modification ICD-10-CM for diagnosis coding and Procedure Coding System ICD-10-PCS for inpatient hospital procedure coding. All covered entities must make the change; a pre-requisite to ICD-10 is the adoption of Version 5010 by Jan. 1, 2012. The implementation of ICD-10 has already been delayed. In January 2009, the date was pushed back by two years, to Oct. 1, 2013 rather than a prior proposal of Oct. 1, 2011.

The present invention relates generally to a disease management method for an individual patient.

More particularly, the present invention generally relates to a method and system to treat a patient with a specific disease state, based on ICD coding, with prescription medications approved by the FDA for said disease state without regard to dosage, quantity or schedule, based on a fee structure adjusted for a fixed period of time.

The prior, but not necessarily relevant, art is exemplified by:
Rubsamen US Patent Application Publication US2001/0034613;
Rubsamen US patent Application Publication US2006/0136272;
Rowe, III et al. US Patent Application Publication US2006/0271402;
Osvald-Murz, “PBM and Pharmaceutical Company Mergers”, leda. law.harvard.edu/leda/data/89/cosvald.html;
Anita R. McGahan, Industry Structure and Competitive Advantage, Harv. Bus. Rev., November-December 1994;
Morse et al. U.S. Pat. No. 7,831,451;
Schlotterbeck et al. U.S. Pat. No. 7,835,927.

Prescription drugs are vital to preventing and treating illness and in helping to avoid more costly medical problems. Rising drug costs, implementation of the Medicare Part D drug benefit in 2006, and expansion of both the number of people covered by health insurance and the breadth of their benefits from the passage of health reform legislation in March 2010 have highlighted the need for new approaches to address increasing prescription costs.

Spending in the US for prescription drugs was $307.1 billion in 2010, nearly 7.5 times the $40.3 billion spent in 1990. Although prescription drug spending has been a relatively small proportion of national health care spending (10% in 2008, compared to 31% for hospitals and 21% for physician services), it has been one of the fastest growing components, until the early 2000's growing at double-digit rates compared to single-digit rates for hospital and physician services. Since 2000, the rate of increase in drug spending has declined each year except for 2006, which was the year Medicare Part D was implemented. By 2008, the annual rate of increase in prescription spending was 3%, compared to 5% for hospital care and 5% for physician services. From 1998 to 2008, prescription drugs contributed 13% of the total growth in national health expenditures, compared to 30% for hospital care and 21% for physician and clinical services.

### Factors Driving Changes in Prescription Spending

Three main factors drive changes in prescription drug spending: changes in the number of prescriptions dispensed (utilization); price changes; and changes in the types of drugs used.

### Utilization

The number of prescriptions dispensed in the US in 2010 increased 1.2% (from 3.9 billion to 4.0 billion), a larger growth rate than the 1.0% increase in 2008 over 2007. From 1999 to 2009, the number of prescriptions increased 39% (from 2.8 billion to 3.9 billion), compared to a US population growth of 9%. The average number of retail prescriptions per capita increased from 10.1 in 1999 to 12.6 in 2009. The percent of the population with a prescription drug expense in 2007 was 62%, the same as in 1997. The proportion of those with an expense varied by age—58% for those under age 65 and 90% for those 65 and older, with little change since 1997 when the proportions were 59% and 86%, respectively.

Recent studies found that the rate of unfilled prescriptions have increased, from both denials (denials are prescriptions that have been submitted to a pharmacy but rejected by a patient's health plan) and abandonment (those that are submitted to a pharmacy but are never picked up). Denials of commercial prescription claims in 2009 were 8.1% for new prescriptions and 4.2% for refills; denials of new brand name drug prescriptions (10.3% in 2009) were up 22.5% since 2006.

A 2009 study found that the cost of drug-related morbidity, including poor adherence (not taking medication as prescribed by doctors) and suboptimal prescribing, drug administration, and diagnosis, is estimated to be as much as $289 billion annually, about 13% of total health care expenditures. The barriers to medication adherence are many:

cost of the medications

side effects

the difficulty of managing multiple prescriptions

patients' understanding of their disease

forgetfulness

complicated or imperfect drug regimens

patients' ability to navigate the health care system (follow-up, lab work)

cognitive impairments

reduced sense of urgency due to asymptomatic conditions

### Price

Prescription drug prices as measured by the Consumer Price Index increased 3.5% in 2010 compared with 1.4% in 2007. The average annual growth in prescription drug prices from 2000 to 2009 was 3.6 percent, compared to 4.1% for all medical care and 2.5% for all items. Industry data show that retail prescription prices rose from an average price of $38.43 in 1998 to $71.69 in 2008; the average brand name prescription price in 2008 was almost 4 times the average generic price ($137.90 vs. $35.22). Of the average retail prescription price of $71.69, manufacturers received 78%, retailers received 17%, and wholesalers received 4% in 2008.

### Changes in Types of Drugs Used

Prescription drug spending is affected when new drugs enter the market and when existing medications lose patent protection. New drugs can increase overall drug spending if they are used in place of older, less expensive medications; if they supplement rather than replace existing drugs treatments; or if they treat a condition not previously treated with drug therapy. New drugs can reduce drug spending if they come into the market at a lower price than existing drug therapies; this can occur when a new drug enters a therapeutic category with one or two dominant brand competitors.

Drug spending is also typically reduced when brand name drugs lose patent protection and face competition from new, lower cost generic substitutes. FDA analysis of 1999-2004 data shows that generic competition is associated with lower drug prices: on average, the first generic competitor prices its product only slightly lower than the brand name manufacturer; the second generic manufacturer reduces the average generic price to nearly half the brand name price; prices continue to fall but more slowly as additional generic manufacturers market the product. For products with a large number of generics, the average generic price falls to 20% of the branded price and lower.

Almost 80% of FDA-approved drugs have generic counterparts. In 2008, 22% of total prescription drug sales and 72% of total prescriptions dispensed were generic medicines. Generic sales grew 8% from 2005 to 2006. Several high-sales brand name drugs are expected to go off-patent in the next 5 years including Lipitor and Plavix, peaking in 2011 and 2012 when 6 of today's 10 largest prescription drugs products in the U.S. are expected to go off patent and face generic competition. While total drug sales may decline as a result, the competition from generic drugs may bring down costs for patients.

### Sales and Profitability

Prescription drug sales were $307.1 billion in 2010, an increase of 5.1% over 2008. This increase was more than 2½ times the 1.9% increase from 2007 to 2008, but lower than the double-digit increases in the early 2000's. IMS Health forecasts a 3%-6% annual growth in the U.S. pharmaceutical market in the next 5 years, reaching $360-$390 billion in 2014. From 1995 to 2002, pharmaceutical manufacturers were the nation's most profitable industry (profits as a percent of revenues). They ranked 3rd in profitability in 2003 and 2004, 5th in 2005, 2nd in 2006, and 3rd in 2007 and 2008, with profits of 19.3% in 2008.

### Insurance Coverage for Prescription Drugs

Lack of insurance coverage for prescription drugs can have adverse effects. An April 2009 survey found that uninsured non-elderly adults (ages 18-64) are more than twice as likely as insured non-elderly adults to say that they or a family member did not fill a prescription (45% vs. 22%) or cut pills or skipped doses of medicine (38% vs. 18%) in the past year because of the cost. Among non-elderly adults in 2008, 27% of the uninsured could not afford a prescription drug in the past 12 months, compared to 13% of those with Medicaid or other public coverage, and 5% of those with employer or other private coverage. A September 2009 survey found that during the past 12 months, 26% of American adults did not fill a prescription, and 21% cut pills in half or skipped doses of medicine, because of cost.

Prescription drug coverage comes from a variety of private and public sources.

### Employer Coverage

Employers are the principal source of health insurance in the United States, providing coverage for 176 million (58%) of Americans in 2008. Sixty percent of employers offered health insurance to their employees in 2009, and 65% of employees in those firms are covered by their employer's health plan. Other employees may have obtained coverage through a spouse. Nearly all (98%) of covered workers in employer-sponsored plans had a prescription drug benefit in 2009.

### Individually Purchased Policies

About 9% of Americans purchased individual coverage in 2008. According to a summer 2009 survey by America's Health Insurance Plans; the vast majority of policies purchased by individuals (rather than employer or other group coverage) had drug benefits.

### Medicare

Prior to Jan. 1, 2006, the traditional Medicare program (the federal health program for the elderly and disabled) did not provide coverage for outpatient prescription drugs. As a result, about one-quarter (27%) of seniors age 65 and older, and one-third of poor (34%) and near-poor (33%) seniors, had no drug coverage in 2003. The Medicare Prescription Drug, Improvement, and Modernization Act of 2003 established a voluntary Medicare outpatient prescription drug benefit (known as Part D), effective Jan. 1, 2006, under which the 47 million eligible Medicare beneficiaries can enroll in private drug plans.

Department of Health and Human Services data show that as of Feb. 16, 2010, approximately 41.8 million (90%) of the 46.5 eligible Medicare beneficiaries had drug coverage. The total number of beneficiaries in a Medicare Part D plans was 27.7 million (60%), including 17.7 million beneficiaries (38%) in stand-alone prescription drug plans and 9.9 million (21%) in Medicare Advantage drug plans. Another 14.2 million beneficiaries (31%) had coverage from either employer or union retiree plans including FEHB and TRICARE (8.3 million, or 18%) and drug coverage from the VA and other sources (5.9 million, or 13%). About 4.7 million Medicare beneficiaries (10%) had no drug coverage.

### Medicaid

Medicaid is the joint federal-state program that pays for medical assistance to 60 million low-income individuals and is the major source of outpatient pharmacy services to the non-elderly low-income population. All state Medicaid programs cover prescription drugs for most beneficiary groups, although there are important differences in state policies with regard to copayments, preferred drugs, and the number of prescriptions that can be filled. Since Jan. 1, 2006, states have been required to make payments to Medicare (known as the “clawback”) to help finance Medicare drug coverage for those who are dually eligible for both Medicare and Medicaid.

### Selected PPACA Changes Affecting Prescription Drug Coverage

The PPACA provisions affecting prescription drug coverage include:

Coverage Expansion:

Provides for a significant expansion of coverage to the uninsured through a Medicaid expansion, an individual requirement to obtain health insurance, and subsidies to help low and middle income individuals buy coverage through newly established Health Benefit Exchanges. PPACA provides that prescription drugs are one of the “essential health benefits” that must be included in health plans in the Exchanges and in the benchmark benefit package or benchmark-equivalent for newly eligible adults under Medicaid.

Medicare Changes:

Provides for a $250 rebate to Medicare Part D beneficiaries with out-of-pocket spending in the Medicare Part D coverage gap in 2010, a 50% discount for brand name drugs for beneficiaries in the coverage gap starting in 2011, a phasing-in of coverage in the gap for generic and brand name drugs which will reduce the beneficiary coinsurance rate from 100% in 2010 to 25% in 2020, a reduction between 2014 and 2019 in the threshold that qualifies enrollees for catastrophic coverage, and elimination of the tax deduction for employers who receive Medicare Part D retiree drug subsidy payments, starting in 2013.

### Responses to Increasing Prescription Drug Costs

A variety of public and private strategies have been implemented to attempt to contain rising costs for prescription drugs.

### Utilization Management Strategies:

Health plans have responded to rising prescription drug costs by increasing enrollee cost-sharing amounts, using formularies to exclude certain drugs from coverage, applying quantity dispensing limits, requiring prior authorization, and using step therapy (starting with the most cost-effective drug and progressing to more costly therapy only if necessary). In 2009, over three-quarters (78%) of workers with employer-sponsored coverage were in plans with 3 or more 4 tiers of cost sharing for prescription drugs, almost 3 times the proportion in 2000 (27%). Worker copayments have increased from 2000-2009: 25% for generic drugs, 80% for preferred drugs, 59% for non-preferred drugs, and 44% for fourth-tier drugs (data from 2004-2009). The average copayment amounts in 2009 were $10 for generics, $27 for preferred drugs, $46 for non-preferred drugs, and $85 for fourth-tier drugs. A 2009 survey of individually purchased health policies found that the vast majority had drug benefits, with copayments being the predominant form of cost sharing.

### Discounts and Rebates:

Private and public drug programs negotiate with pharmaceutical manufacturers (often using contracted organizations known as pharmacy benefit managers) to receive discounts and rebates which are applied based on volume, prompt payment, and market share. Manufacturers who want their drugs covered by Medicaid must provide rebates to state Medicaid programs for the drugs they purchase; many states have also negotiated additional rebates, known as supplemental rebates.

Several federal government agencies, including the Department of Veterans Affairs, the Defense Department, the Public Health Service, and the Coast Guard, participate in a program known as the Federal Supply Schedule through which they purchase drugs from manufacturers at prices equal to or lower than those charged to their “most-favored” nonfederal purchasers.

### Medicaid:

Historically, prescription drugs have been one of the fastest-growing Medicaid services, The Deficit Reduction Act of 2005 gave states more authority to control Medicaid drug spending through increased cost sharing for non-preferred drugs, changes in the way Medicaid pays pharmacists, allowing pharmacists to refuse prescriptions for beneficiaries who do not pay their cost sharing, and inclusion of authorized generic drugs in the calculation of “best price” for drugs. A 2009 survey of 50 states+DC found that more than half had Medicaid pharmacy cost containment measures in place by FY2009, including preferred drug lists and prior authorization programs (about 45% of states), supplemental rebates from manufacturers and state Maximum Allowable Cost programs for generic and multi-source brand drugs (44%); smaller proportions of states were members of multi-state purchasing coalitions (26%) or had limits on quantities dispensed per prescription (16%). Medicaid requires drug manufacturers who want to sell their products to Medicaid patients to agree to pay rebates to states for outpatient drugs purchased on behalf of Medicaid beneficiaries. PPACA increases the Medicaid drug rebate percentages for several types of outpatient drugs and requires that the resulting savings be remitted to the federal government.

### Medicare:

The Medicare Part D drug benefit shifted spending from the private sector and Medicaid to Medicare, making Medicare the nation's largest public payer of prescription drugs (from 7% in 2005 to 60% in 2008). Medicare prescription drug spending as a share of total US prescription spending rose from 2% in 2005 to 22% in 2008. Medicare prescription drug spending totaled $52.1 billion in 2008, an increase of 13% over 2007. Part D plans use various cost containment approaches including tiered cost sharing, formulary coverage that varies considerably across plans, and utilization management (UM) restrictions such as prior authorization, step therapy, or quantity limits; UM use among stand-alone drug plans has increased from 18% in 2007 to 28% in 2009. Medicare is prohibited by law from directly negotiating drug prices or rebates with manufacturers to control costs.

### Purchasing Pools:

Public and private organizations have banded together to form prescription drug purchasing pools to increase their purchasing power through higher volume and shared expertise. Examples include joint purchasing by the Department of Defense and VA; multi-state bulk buying pools through which states purchase drugs for their Medicaid, state employees, senior/low-income/uninsured pharmacy assistance programs, or other public programs; and individual state purchasing pools.

### Consumers:

Consumers are turning to a variety of methods to reduce their prescription costs, including requesting cheaper drugs or generic drugs from their physicians and pharmacies, using the Internet and other sources to make price comparisons, using the Internet to purchase drugs, buying at discount stores, buying over-the-counter instead of prescribed drugs, buying drugs in bulk and pill-splitting, using mail-order pharmacies, and using pharmaceutical company or state drug assistance programs. Over half of physicians say they frequently talk with patients about the out of-pocket costs of medicines they prescribe, 62% say they switch patients to less expensive drugs, and 58% say they give patients office samples.

### Importation:

The high cost of prescriptions has led some to suggest that individuals be permitted to purchase prescription products from distributors in Canada or other countries (called “importation,” or “re-importation” if the drug is manufactured in the US). Although it is generally not lawful for individuals or commercial entities such as pharmacies or wholesalers to purchase prescription drugs from other countries, the government does not always act to stop individuals from purchasing drug products abroad. Importation of pharmaceutical products from Canada through Internet sales and travel to Canada totaled about $700 million in sales in 2003, or 0.3% of total US prescription sales. An equivalent amount of prescription drugs was estimated to have entered the US from the rest of the world, mostly through the mail and courier services. P.L. 109-295 (enacted in 2006) allows US residents to transport up to a 90-day supply of qualified drugs from Canada to the US. Importation issues such as actual savings amounts, drug safety, and marketplace competition and pricing continue to be debated.

It is a desideratum of the present invention to avoid the animadversions of conventional disease management systems and methods.

### SUMMARY OF THE INVENTION

The present invention provides a disease management method for an individual patient, comprising the steps of: determining the individual patient's particular ICD coding as a primary condition; determining the individual patient's additional ICD codings as a co-morbid or secondary condition(s); determining the individual patient's additional ICD coding which are a result of drugs prescribed for the primary and/or secondary ICD codings as a result of treatment for the primary, co-morbid or secondary condition(s); determining the individual patient's primary and secondary ICD codings will preclude certain medications from being used to treat the primary ICD coding as a secondary ICD coding may result in a contraindication of a class of FDA-approved medications from being used to treat the patient; and calculating a cost to treat the primary or secondary ICD coding based on a fee structure adjusted for a fixed period of time, and which factors in drugs being excluded and be reflected in the cost offered to the patient or health plan.

It is an object of the invention to provide a method as described hereinabove which includes the step of determining all of the drugs which are FDA-approved for a specific disease state (ICD coding) for the individual patient.

Another object of the invention to provide a method as described hereinabove wherein said cost includes a fee associated with the cost of the drugs for each ICD coding.

A further object of the invention to provide a method as described hereinabove including the steps of: determining all drugs the patient is currently taking for a particular ICD coding; determining all drugs the patient have used for said particular ICD coding (disease) in the past unsuccessfully; and determining the costs of all drugs approved for said particular ICD coding which have not yet been prescribed for the patient.

Yet another object of the invention to provide a method as described hereinabove wherein the method is used for treating the patient in any healthcare setting with prescription drugs based on a disease state for an annual fixed fee.

A further object of the invention to provide a method as described hereinabove wherein the method treats a primary disease in the patient who also has one or more secondary diseases, while precluding treatment with certain drugs, which although being approved for said primary disease, that would be detrimental to the patient's likelihood of successful drug therapy.

Another object of the invention to provide a method as described hereinabove which does not use capitated rates.

A further object of the invention is to provide a method and system to treat a patient, in any healthcare setting, diagnosed with a specific disease state, according to ICD coding, with prescription medications regardless of dosage, quantity or schedule of the drugs approved by the FDA for one annual fixed fee.

Yet another object of the invention is based on utilization of the National Drug Code (NDC) because it is a recognized universal product identifier for all human drug products. These drugs are represented as a list of all drugs manufactured, prepared, propagated, compounded or processed for commercial distribution.

Another object of the invention is to provide a method and system to treat a patient's co-morbid condition, in any healthcare setting, with prescription medications regardless of dosage, quantity or schedule for one annual fixed fee.

Another object of the invention is to provide a method and system to treat a patient's adverse effects associated with the pharmacologic agents used to treat the primary disease state or the co-morbid disease states in any healthcare setting, with prescription medications regardless of dosage, quantity or schedule for one annual fixed fee.

Another object of the invention is the utilization of clinical practice guidelines from the National Cancer Care Network (NCCN) which defines categories based on drug evidence and consensuses based on their appropriateness of use and are therefore used for the treatment of specific conditions and supports payer coverage determinations.

Another object of the invention is to provide an Internet-based, automated computerized software program that will allow an individual to enter her/his current prescription regimen for a particular disease state.

These and other objectives are achieved by providing a new and improved computerized system for performing steps of the method in an effective, convenient and economical prescription medication dispensing system.

Techniques include novel developments, implementations and applications of technologies to standardize the inventive process so that it may be applied conveniently, safely, economically and report accurate results.

Other objects, advantages, and features of the present invention will become apparent to those persons skilled in this particular area of technology and to other persons after having been exposed to the present patent application when read in conjunction with the accompanying patent drawing.

### BRIEF DESCRIPTION OF THE DRAWINGS

Drawing 1 depicts a treatment algorithm flowchart which details evaluation, diagnosis, staging, prescribing of prescription medications for a single disease state.

Drawing 2 depicts a chart listing the single agents approved to treat hypertension arranged according to pharmacological activity.

Drawing 3 depicts a chart listing the combination agents (two or more drugs) approved to treat hypertension arranged according to pharmacological activity.

Drawing 4 depicts a chart listing the single agents approved to treat hypertension arranged according to pharmacological activity and considered first-line agents based on Joint National Committee on Treatment of Hypertension (JNC-7) guidelines.

Drawing 5 depicts a chart listing the combination agents approved to treat hypertension arranged according to pharmacological activity and considered first-line agents based on JNC-7 guidelines.

Drawing 6 depicts a chart listing the single agents approved to treat diabetes Type II arranged according to pharmacological activity.

Drawing 7 depicts a chart listing the single agents approved to treat diabetes Type II arranged according to pharmacological activity and considered first-line agents based on recommendations from consensus statements from the American Diabetes Association, American Association of Clinical Endocrinologists and American College of Endocrinology.

Drawing 8 depicts a combination chart listing agents approved to treat hypertension as well as agents approved to treat diabetes Type II; both being arranged according to pharmacological activity, and considered first line therapies in the treatment of a patient with a primary ICD coding for hypertension and a secondary ICD coding for diabetes type II.

### DETAILED DESCRIPTION OF THE INVENTION

The following detailed description is of the best currently contemplated modes of carrying out exemplary embodiments of the invention.

The description is not to be taken in a limiting sense, but is made merely for the purpose of illustrating the general principles of the invention, since the scope of the invention is best defined by the appended claims.

The present invention has many desirable features, such as the ability to treat a patient with a known disease state with any and all medications that are deemed pharmacologically appropriate as evidenced by FDA indication and a positive treatment response (efficacy) and/or a lack of negative treatment response (toxicity).

An annual fixed fee system would allow the practitioner to prescribe the appropriate agent or agents for the patient's condition, to titrate the dosage of the drug or drugs, and schedule of the medication or medications without regard to the increased financial burden normally associated with these events.

Upon diagnosing the disease state to be treated, the practitioner can choose from a pharmacologically appropriate category or categories of drugs and prescribe according to and within the FDA recognized dosage guidelines and schedules for each agent.

Oftentimes many disease states require more than one pharmacologic category of drugs.

If a co-morbid disease state exists for the same patient, as defined by a second ICD code, the practitioner would prescribe additional agents for that particular disease state, titrate both the dosage of said drug or drugs and the schedule of the medication or medications based on the patients positive treatment response (efficacy) and/or a lack of negative treatment response (toxicity). Treatment of the co-morbid state would be covered under a separate second fixed fee structure.

First an internet-based system on-line tutorial would be reviewed to familiarize the prescriber with the application, logic, and operation of the disease state fixed fee system. A prescriber enters a disease state, based on the ICD coding system, and the categories of appropriate pharmaceutical agents are listed. The prescriber chooses from one or more categories of agents based on the patient's demographics, physiology, severity of illness, contraindications, existing pharmacologic therapies and advantages or disadvantages of certain categories of pharmacological agents.

After a period of time has elapsed the prescriber will reassess the current pharmacologic regimen and titrate the dosage(s) and/or the schedule(s) of the current drug regimen according to the patient's response and/or prescribe a new pharmacological agent.

The process is repeated periodically until the patient receives maximum pharmacologic benefit from the drug regimen that may include several different classes of pharmacologic agents.

The steps in prescribing are as follows:
Define the diagnosis
Specify the therapeutic objective.
Develop and inventory of effective categories of agents based of mechanism of action.
Choose an effective category according to recognized criteria based on efficacy, safety, suitability of route of administration, dosage and dosing schedule and cost of treatment.
Choose an individual agent and dosage form, dosing schedule, duration of treatment or monitoring interval for reassessment of the efficacy of the pharmacotherapy.

The following chart is useful in implementing the foregoing.

| | | Usual dose range in | | Usual Daily |
|---|---|---|---|---|
| Class | Generic/trade name | mg/day | | Frequency |
| Thiazide Diuretics | Chlorothiazide (Diuril) | 125-500 | mg/day | 1-2 |
| | Chlorthalidone | 12.5-25 | mg/day | 1 |
| | Hydrochlorothiazide | 12.5-50 | mg/day | 1 |
| | Polythiazide | 2-4 | mg/day | 1 |
| | Indapamide (Lozol) | 1.25-2.5 | mg/day | 1 |
| | Metolazone (Zaroxolyn) | 2.5-5 | mg/day | 1 |
| Loop Diuretics | Bumetanide (Bumex) | 0.5-2 | mg/day | 2 |
| | Furosemide (Lasix) | 10-80 | mg/day | 2 |
| | Torsemide (Demadex) | 2.5-10 | mg/day | 1 |
| Potassium-sparing | Amiloride (Midamor) | 5-10 | mg/day | 1-2 |
| diuretics | Triamterene (Dyrenium) | 50-100 | mg/day | 1-2 |
| Aldosterone receptor | Eplerenone (Inspra) | 50-100 | mg/day | 1 |
| blockers | Spironolactone (Aldactone) | 25-50 | mg/day | 1 |
| Beta Blockers | Atenolol (Tenormin) | 25-100 | mg/day | 1 |
| | Betaxolol (Kerlone) | 5-20 | mg/day | 1 |
| | Bisoprolol (Zebeta) | 2.5-10 | mg/day | 1 |
| | Metoprolol (Lopressor) | 50-100 | mg/day | 1-2 |
| | Metoprolol extended release | 25-100 | mg/day | 1 |
| | (Toprol XL) | 40-120 | mg/day | 1 |
| | Nadolol (Corgard) | 40-160 | mg/day | 2 |
| | Propranolol (Inderal) | 60-180 | mg/day | 1 |
| | Propranolol long acting | 20-40 | mg/day | 2 |
| | (Inderal LA) | | | |
| | Timolol (Blocadren) | 5-60 | mg/day | 2 |
| Beta Blockers with | Acebutolol (Sectral) | 200-800 | mg/day | 2 |
| intrinsic | Penbutolol (Levatol) | 10-40 | mg/day | 1 |
| sympathomimetic | Pindolol (generic) | 10-40 | mg/day | 2 |
| activity | | | | |
| Combined alpha and | Carvedilol (Coreg) | 12.50-50 | mg/day | 2 |
| beta blockers | Labetolol (Normodyne, | 200-800 | mg/day | 2 |
| | Trandate) | | | |
| Angiotensin | Benazepril (Lotensin) | 10-40 | mg/day | 1 |
| Converting Enzyme | Captopril (Capoten) | 25-100 | mg/day | 2 |
| Inhibitors (ACEI) | Enalapril (Vasotec) | 5-40 | mg/day | 1-2 |
| | Fosinopril (Monopril) | 10-40 | mg/day | 1 |
| | Lisinopril (Prinvil, Zestril) | 10-40 | mg/day | 1 |
| | Moexepril (Univasc) | 7.5-30 | mg/day | 1 |
| | Perindopril (Aceon) | 4-8 | mg/day | 1 |
| | Quinapril (Accupril) | 10-80 | mg/day | 1 |
| | Ramipril (Altace) | 2.5-20 | mg/day | 1 |
| | Trandolapril (Mavik) | 1-4 | mg/day | 1 |
| Angiotensin II | Candesartan (Atacand) | 8-32 | mg/day | 1 |
| antagonists | Eprosartan (Teveten) | 400-800 | mg/day | 1-2 |
| | Irbesartan (Avapro) | 150-300 | mg/day | 1 |
| | Losartan (Cozaar) | 25-100 | mg/day | 1-2 |
| | Olmesartan (Benicar) | 20-40 | mg/day | 1 |
| | Telmisartan (Micardis) | 20-80 | mg/day | 1 |
| | Valsartan (Diovan) | 80-320 | mg/day | 1-2 |
| Calcium-channel | Diltiazem extended release | 180-420 | mg/day | 1 |
| blockers (CCB) non- | (Cardizem CD, Dilacor XR, | 120-540 | mg/day | 1 |
| dihydropyridines | Tiazac) | | | |
| | Diltiazem extended release | 80-320 | mg/day | 2 |
| | (Cardizem LA) | | | |
| | Verapamil immediate release | 120-480 | mg/day | 1-2 |
| | (Calan, Isoptin) | | | |
| | Verapamil long acting | 120-360 | mg/day | 1 |
| | (Calan SR, Isoptin SR) | | | |
| | Verapamil extended release | 120-480 | mg/day | 2 |
| | (Covera HS, Verelan PM) | | | |
| Calcium-channel | Amlodipine (Norvasc) | 2.5-10 | mg/day | 1 |
| blockers (CCB) | Felodipine (Plendil) | 2.5-20 | mg/day | 1 |
| (dihydropyridines) | Isradapine (Dynacirc CR) | 2.5-10 | mg/day | 2 |
| | Nicardipine sustained release | 60-120 | mg/day | 2 |
| | (Cardene SR) | | | |
| | Nicardipine long-acting | 30-60 | mg/day | 1 |
| | (Adalat CC, Procardia XL) | | | |
| | Nisoldipine (Sular) | 10-40 | mg/day | 1 |
| Alpha-1 blockers | Doxazosin (Cardura) | 1-16 | mg/day | 1 |
| | Prazosin (Minipres) | 2-20 | mg/day | 2-3 |
| | Terazosin (Hytrin) | 1-20 | mg/day | 1-2 |
| Central alpha-2 | Clonidine (Catapres) | 0.1-0.8 | mg/day | 2 |
| agonists and other | Clonidine patch (Catapres | 0.1-0.3 | mg/day | 1 weekly |
| centrally acting drugs | TTS) | 250-1000 | mg/day | 2 |
| | Methyldopa (Aldomet) | 0.1-0.25 | mg/day | 1 |
| | Reserpine (generic) | 0.5-2 | mg/day | 1 |
| | Guanfacine (Tenex) | 1-3 | mg/day | 1 |
| Direct vasodilators | Hydralazine (Apresoline) | 25-100 | mg/day | 2 |
| | Minoxidil (Loniten) | 2.5-80 | mg/day | 1-2 |

| Combination Type | Fixed-Dose Combination (mg) | Trade Name |
|---|---|---|
| ACEIs and CCBs | Amlodipine-Benazepril (2.5/10, 5/10, 5/20, 10/20) | Lotrel |
| | Enalapril-Felodipine (5/5) | Lexxel |
| | Trandolapril-Verapamil (2/180, 1/240. 2/240, 4/240) | Tarka |
| ACEIs and | Benazepril-HCTZ (5/6.25, 10/12.5, 20/12.5, 20/25) | Lotensin HCT |
| diuretics | Captopril-HCTZ (25/15, 25/25, 50/15, 50/25) | Capozide |
| | Enalapril-HCTZ (5/12.5, 10/25) | Vaseretic |
| | Fosinopril-HCTZ (10/12.5, 20/12.5) | Monopril HCT |
| | Lisinopril-HCTZ (10/12.5, 20/12.5, 20/25) | Prinzide, Zestoretic |
| | Moexepril-HCTZ (7.5/12.5, 15/25) | Uniretic/ |
| | Quinapril-HCTZ (10/12.5, 20/12.5, 20/25) | Accuretic |
| ARBs and diuretics | Candesartan-HCTZ (16/12.5, 32/12.5) | Atacand HCT |
| | Eprosartan-HCTZ (600/12.5, 600/12.5) | Teveten HCT |
| | Irbesartan-HCTZ (150/12.5, 300/12.5) | Avalide |
| | Losartan-HCTZ (50/12.5, 100/25) | Hyzaar |
| | Olmesartan-HCTZ (20/12.5, 40/12.5, 40/25) | Benicar HCT |
| | Telmisartan-HCTZ (40/12.5, 80/12.5) | Micardis HCT |
| | Valsartan-HCTZ 80/12.5, 160/12.5, 160/25) | Diovan HCT |
| BBs and diuretics | Atenolol-HCTZ (50/25, 100/25) | Tenoretic |
| | Bisoprolol-HCTZ (2.5/6.25, 5/6.25, 10/6.25) | Ziac |
| | Metoprolol-HCTZ (50/25, 100/25) | Lopressor HCT |
| | Nadolol-HCTZ (40/5, 80/5) | Corzide |
| | Propranolol LA-HCTZ (40/25, 80/25) | Inderide LA |
| | Timolol-HCTZ (10/25) | Timolide |
| Centrally acting | Methyldopa-HCTZ (250/15, 250/25, 500/30, 500/50) | Aldoril |
| drug-diuretic | Reserpine-Chlorthalidone (0.125/25, 0.25/50) | Demi-Regreton |
| | Reserpine Chlorothiazide (0.125/250, 0.25/500) | Diupres |
| | Reserpine-HCTZ (0.125/25, 0.125/50) | Hydropres |
| Diuretic-diuretic | Amiloride-HCTZ (5/50) | Moduretic |
| | Spironolactone-HCTZ (25/25, 50/50) | Aldactazide |
| | Triamterene-HCTZ (37.5/25, 75/50) | Dyazide, Maxzide |

The methodology of the present invention is based on determining/recognizing all of the drugs that are FDA-approved for a specific disease state (ICD coding) for an individual patient. There would be a fee associated with cost of the drugs for each ICD coding.

The methodology of the present invention also is based on determining/recognizing any drugs the patient is currently taking for a particular ICD coding; as well as those the patient has used for the same ICD coding (disease) in the past unsuccessfully; and determining/recognizing the costs of any medications that are approved for the ICD coding for which that the patient has not yet been prescribed.

The methodology of the present invention also is based on determining/recognizing the individual patient's particular ICD coding as a primary condition; determining/recognizing the individual patient's additional ICD codings as a co-morbid or secondary condition(s); determining/recognizing the individual patient's additional ICD codings that are a result of the drugs prescribed for the primary ICD and/or secondary ICD codings as a result of treatment for the primary, co-morbid or secondary condition(s); determining/recognizing the individual patient's primary and secondary ICD codings will preclude certain medications from being used to treat the primary ICD coding as a secondary ICD coding may result in a contraindication of a class of FDA-approved medications from being used to treat the patient.; and calculating the cost to treat the primary or secondary ICD coding would factor in the drugs being excluded and be reflecting in the cost offered the patient or health plan.

The accompanying drawings provide an overview for using the methodology in the treatment of a patient with a primary diagnosis of hypertension and a secondary diagnosis of diabetes Type II.

The point of the drawing is to demonstrate that treating a primary disease in patients with secondary diseases precludes treatment with certain drugs, that although they have approval for the primary disease, they would be detrimental to the patient's likelihood of successful drug therapy.

It should be understood, of course, that the foregoing relates to only some exemplary embodiments of the invention and that modifications may be made without departing from the spirit and scope of the invention as set forth in the following claims.

There has been illustrated in the accompanying drawing and described hereinabove only some possible unique and novel embodiments of the present invention which can be practiced and constructed in many different applications, embodiments, and configurations.

It should be understood that many changes, modifications, variations, and other uses and applications will become apparent to those persons skilled in this particular area of technology and to others after having been exposed to the present patent specification and accompanying drawing.

Any and all such changes, modifications, variations and other uses and applications which do not depart from the spirit and scope of the present invention are therefore covered by and embraced within the present invention and the patent claims set forth herein below.

1. A disease management method for an individual patient, comprising the steps of:
determining the individual patient's particular ICD coding as a primary condition;
determining the individual patient's additional ICD codings as a co-morbid or secondary condition(s);
determining the individual patient's additional ICD coding which is a result of drugs prescribed for the primary and/or secondary ICD codings as a result of treatment for the primary, co-morbid or secondary condition(s);
determining the individual patient's primary and secondary ICD codings will preclude certain medications from being used to treat the primary ICD coding as a secondary ICD coding may result in a contraindication of a class of FDA-approved medications from being used to treat the patient; and
calculating a cost to treat the primary or secondary ICD coding based on a fee structure adjusted for a fixed period of time, and which factors in drugs being excluded and be reflected in the cost offered to the patient or health plan.

2. The method of claim 1, including the step of:
determining all of the drugs which are FDA-approved for a specific disease state (ICD coding or clinically-based evidence from NCCN categories) for the individual patient.

3. The method of claim 1, wherein:
said cost includes a fee associated with the cost of the drugs for each ICD coding.

4. The method of claim 2, wherein:
said cost includes a fee associated with the cost of the drugs for each ICD coding.

5. The method of claim 1, including the steps of:
determining all drugs the patient is currently taking for a particular ICD coding;
determining all drugs the patient have used for said particular ICD coding (disease) in the past unsuccessfully; and
determining the costs of all drugs approved for said particular ICD coding which have not yet been prescribed for the patient.

6. The method of claim 2, including the steps of:
determining all drugs the patient is currently taking for a particular ICD coding;
determining all drugs the patient have used for said particular ICD coding (disease) in the past unsuccessfully; and
determining the costs of all drugs approved for said particular ICD coding which have not yet been prescribed for the patient.

7. The method of claim 3, including the steps of:
determining all drugs the patient is currently taking for a particular ICD coding;
determining all drugs the patient have used for said particular ICD coding (disease) in the past unsuccessfully; and
determining the costs of all drugs approved for said particular ICD coding which have not yet been prescribed for the patient.

8. The method of claim 4, including the steps of:
determining all drugs the patient is currently taking for a particular ICD coding;
determining all drugs the patient have used for said particular ICD coding (disease) in the past unsuccessfully; and
determining the costs of all drugs approved for said particular ICD coding which have not yet been prescribed for the patient.

9. The method of claim 1, wherein:
the method is used for treating the patient in any healthcare setting with prescription drugs based on a disease state for a defined time period for a fixed fee.

10. The method of claim 2, wherein:
the method is used for treating the patient in any healthcare setting with prescription drugs based on a disease state for a defined time period for a fixed fee.

11. The method of claim 3, wherein:
the method is used for treating the patient in any healthcare setting with prescription drugs based on a disease state for a defined time period for a fixed fee.

12. The method of claim 4, wherein:
the method is used for treating the patient in any healthcare setting with prescription drugs based on a disease state for a defined time period for a fixed fee.

13. The method of claim 5, wherein:
the method is used for treating the patient in any healthcare setting with prescription drugs based on a disease state for a defined time period for a fixed fee.

14. The method of claim 6, wherein:
the method is used for treating the patient in any healthcare setting with prescription drugs based on a disease state for a defined time period for a fixed fee.

15. The method of claim 7, wherein:
the method is used for treating the patient in any healthcare setting with prescription drugs based on a disease state for a defined time period for a fixed fee.

16. The method of claim 8, wherein:
the method is used for treating the patient in any healthcare setting with prescription drugs based on a disease state for a defined time period for a fixed fee.

17. The method of claim 1, wherein:
the method treats a primary disease in the patient who also has one or more secondary diseases, while precluding treatment with certain drugs, which although being approved for said primary disease, that would be detrimental to the patient's likelihood of successful drug therapy.

18. The method of claim 9, wherein:
the method treats a primary disease in the patient who also has one or more secondary diseases, while precluding treatment with certain drugs, which although being approved for said primary disease, that would be detrimental to the patient's likelihood of successful drug therapy.

19. The method of claim 10, wherein:
the method treats a primary disease in the patient who also has one or more secondary diseases, while precluding treatment with certain drugs, which although being approved for said primary disease, that would be detrimental to the patient's likelihood of successful drug therapy.

20. The method of claim 16, wherein:
the method treats a primary disease in the patient who also has one or more secondary diseases, while precluding treatment with certain drugs, which although being approved for said primary disease, that would be detrimental to the patient's likelihood of successful drug therapy.
